(19) United States
(12) Patent Application Publication
(10) Pub. No.: US 2022/0228854 A1
(43) Pub. Date: Jul. 21, 2022

(54) MEASUREMENT DEVICE AND MEASUREMENT METHOD

(71) Applicant: Otsuka Electronics Co., Ltd., Osaka (JP)

(72) Inventors: Yuki SASAKI, Hirakata-shi (JP); Kenji NAKAMURA, Hirakata-shi (JP); Wataru MIZUNO, Hirakata-shi (JP)

(73) Assignee: Otsuka Electronics Co., Ltd., Osaka (JP)

(21) Appl. No.: 17/595,953

(22) PCT Filed: Jun. 27, 2019
(86) PCT No.: PCT/JP2019/025640

§ 371 Date: Nov. 30, 2021

(51) Int. Cl. G01B 11/24

(52) U.S. Cl. CPC G01B 11/24; G02B 27/144

(57) ABSTRACT

A measurement device is a measurement device for measuring the shape of a measurement subject, and includes: a light source unit; a light receiving unit; and a main body that includes a light passing portion from which a line-shaped light ray is emitted, a light projection optical path that is an optical path extending from the light source unit to the light passing portion, and a light receiving optical path that is an optical path extending from the light passing portion to the light receiving unit.

### TECHNICAL FIELD

The present invention relates to a measurement device and a measurement method for measuring the shape of a measurement subject.

### BACKGROUND ART

Conventionally, a measurement device for measuring the shape of the surface of a measurement subject has been developed. For example, Patent Document 1 (JP 2015-75452A) discloses the shape measurement device described below, as an example of such a measurement device. That is, a shape measurement device includes: a translucent optical component that has a reference surface that faces a surface of a sample; a light source that irradiates the surface of the sample with light that has a predetermined wavelength band and passes through the optical component; an imaging spectroscope that measures a reflection spectrum for each position in a linear region that is defined on the surface of the sample; and a calculation unit that calculates a distance between each position in the linear region and the reference surface based on the reflection spectrum measured for each position in the linear region.

Also, Patent Document 2 (JP 2012-7961A) discloses the shape measurement device described below. That is, a shape measurement device includes: a light projecting device that irradiates an uneven shape of a measurement subject with line light; an imaging device that captures an image of a light cutting line formed in the uneven shape by the light projecting device; a driving device that moves the light projecting device in a light emission axis direction thereof so that the width of the light cutting line is the smallest on an upper base and a lower base of the uneven shape; and a processing device that calculates a height or a depth of the uneven shape based on an image in which the width of the light cutting line is a minimum on the upper base of the uneven shape and an image in which the width of the light cutting line is a minimum on the lower base of the uneven shape, the images being captured by the imaging device.

### CITATION LIST

### Patent Documents

Patent Document 1: JP 2015-75452A
Patent Document 2: JP 2012-7961A

### DISCLOSURE OF THE INVENTION

### Problem to be Solved by the Invention

There is demand for a measurement device that is superior to the techniques described in Patent Document 1 and Patent Document 2, and makes it easier to measure the shapes of various measurement subjects.

The present invention has been made to solve the above-described problem, and aims to provide a measurement device and a measurement method that make it easier to measure the shapes of various measurement subjects.

### Means for Solving the Problem

(1) To solve the above-described problem, a measurement device according to one aspect of the invention is the measurement device for measuring the shape of a measurement subject, the measurement device includes: a light source unit; a light receiving unit; and a main body that includes a light passing portion from which a line-shaped light ray is emitted, a light projection optical path that is an optical path extending from the light source unit to the light passing portion, and a light receiving optical path that is an optical path extending from the light passing portion to the light receiving unit.

As described above, with a configuration that includes the main body that includes the light passing portion, the light projection optical path, and the light receiving optical path, it is possible to radiate the measurement subject with the line-shaped light ray emitted from the light passing portion, in a state where the light passing portion faces the measurement subject. Therefore, for example, in a state where the measurement subject is placed on the main body such that the light passing portion and the measurement subject face each other, it is possible to measure the shape of the measurement subject, using the line-shaped light ray emitted from the light passing portion. Therefore, it is easier to measure the shapes of various measurement subjects.

(2) Preferably, the measurement further includes: a light projecting mirror that is provided on the light projection optical path; and a light receiving mirror that is provided on the light receiving optical path, wherein the light projecting mirror reflects light received from the light source unit so that the measurement subject is irradiated therewith through the light passing portion, and the light receiving mirror reflects at least some of the light received from the measurement subject through the light passing portion so that the light receiving unit is irradiated therewith.

With such a configuration, it is possible to freely design the light projection optical path and the light receiving optical path in the main body, using the light projecting mirror and the light receiving mirror. Therefore, it is possible to flexibly determine the shape and size of the main body according to the shape measurement of the measurement subject.

(3) More preferably, the measurement device further includes a half mirror that is provided at a position on the light projection optical path between the light source unit and the light projecting mirror.

With such a configuration, using the light projecting mirror and the half mirror, it is possible to irradiate a plurality of areas of the measurement subject with reflected light rays received from the light source, and simultaneously measure the shapes of the plurality of areas of the measurement subject.

(4) Preferably, the measurement device further includes an analysis unit that analyzes the shape of the measurement subject based on a light reception result of the light receiving unit, wherein the analysis unit further generates an image based on the light reception result of the light receiving unit, and detects an object other than the measurement subject based on an analysis result of the image thus generated.

With such a configuration, using the image of the area of the measurement subject irradiated with the line-shaped light ray, it is possible to detect the object such as foreign matter, based on the result of visual analysis of the area, for example.

(5) Preferably, the measurement device further includes an adjustment mechanism configured to adjust an incident angle of a light ray travelling from the light projection optical path to the light passing portion.

With such a configuration, it is possible to adjust the incident angle of the light ray travelling from the light projection optical path to the light passing portion. Therefore, it is possible to measure the shapes of a wider variety of measurement subjects.

(6) Preferably, the light passing portion is an opening, the main body further includes a transparent member that closes the opening, and the transparent member is provided on the other side of the measurement subject with respect to the opening.

As described above, with a configuration in which the transparent member closes the opening, it is possible to prevent dust or the like from entering the main body. In addition, with a configuration in which the transparent member is provided on the other side of the measurement subject with respect to the opening, it is possible to prevent the measurement subject located so as to face the opening from coming into contact with the transparent member. Therefore, in the case of measuring the shape of the measurement subject in a state where the measurement subject is placed over the opening, for example, it is possible to prevent the measurement subject from deforming under its own weight, and perform more accurate shape measurement.

(7) To solve the above-described problem, a measurement method according to one aspect of the invention is the measurement method carried out by a measurement device for measuring the shape of a measurement subject, the measurement device including a main body, the main body including a light passing portion, a light projection optical path, and a light receiving optical path, the measurement method includes: a step of irradiating the measurement subject with a line-shaped light ray that enters the light projection optical path or a line-shaped light ray that is generated on the light projection optical path, through the light passing portion; and a step of receiving a reflected light ray from the measurement subject, through the light passing portion and the light receiving optical path.

As described above, with a method that employs the measurement device that includes the light passing portion, the light projection optical path, and the light receiving optical path, to irradiate the measurement subject with the line-shaped light ray through the light passing portion and receive the reflected light ray from the measurement subject through the light passing portion and the light receiving, it is possible to irradiate the measurement subject with the line-shaped light ray, in a state where the light passing portion faces the measurement subject. Therefore, for example, in a state where the measurement subject is placed on the main body such that the light passing portion and the measurement subject face each other, it is possible to measure the shape of the measurement subject, using the line-shaped light ray emitted from the light passing portion. Therefore, it is easier to measure the shapes of various measurement subjects.

### Effects of the Invention

With the present invention, it is easier to measure the shapes of various measurement subjects.

### BRIEF DESCRIPTION OF THE DRAWINGS

FIG. 1 is a side view showing a configuration of a measurement device according to an embodiment of the present invention.

FIG. 2 is a plan view showing light that is emitted from the opening of the measurement device according to the embodiment of the present invention, and with which the measurement subject is irradiated.

FIG. 3 is a diagram showing a light irradiation line that is formed in the measurement area, by the line light ray emitted from the measurement device according to the embodiment of the present invention, with which the measurement subject is irradiated.

FIG. 4 is a diagram showing a state in which the line light ray emitted from the measurement device according to the embodiment of the present invention so that the measurement subject is irradiated therewith is reflected by the surface of the measurement subject.

FIG. 5 is a diagram showing an example of an image generated by the analysis unit of the measurement device according to the embodiment of the present invention.

FIG. 6 is a diagram showing the result of the analysis of the surface shape of the measurement subject performed by the analysis unit of the measurement device according to the embodiment of the present invention.

FIG. 7 is a plan view showing an example of a measurement area that is to be irradiated with a line light ray emitted from the measurement device according to the embodiment of the present invention.

FIG. 8 is a diagram showing an example of the content of a measurement performed by the measurement device according to the embodiment of the present invention.

FIG. 9 is a diagram showing another example of the content of a measurement performed by the measurement device according to the embodiment of the present invention.

FIG. 10 is a side view showing a configuration of a measurement device according to a modification of the embodiment of the present invention.

FIG. 11 is a flowchart showing operation procedures that are performed by the measurement device according to the embodiment of the present invention when analyzing the surface shape of the measurement area of the measurement subject.

### DESCRIPTION OF EMBODIMENTS

Hereinafter, embodiments of the present invention will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### Configuration and Basic Operations

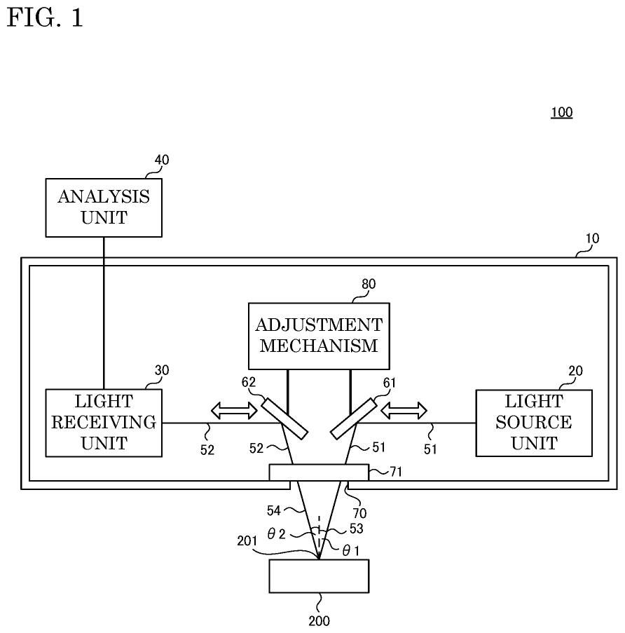

FIG. 1 is a side view showing a configuration of a measurement device according to an embodiment of the present invention.

As shown in FIG. 1, a measurement device 100 includes a main body 10, a light source unit 20, and a light receiving unit 30. The measurement device 100 is a device for measuring the shape of a measurement subject 200. The light source unit 20 and the light receiving unit 30 are provided inside the main body 10, for example. The main body 10 is a housing in which the light source unit 20 and the light receiving unit 30 are provided, for example.

The main body 10 includes an opening 70, a light projection optical path 51, and a light receiving optical path 52. The light projection optical path 51 is an optical path extending from the light source unit 20 to the opening 70. The light receiving optical path 52 is an optical path extending from the opening 70 to the light receiving unit 30. Due to light from the light source unit 20, for example, a line-shaped light ray is emitted from the opening 70. The opening 70 is an example of a light passing portion.

The light source unit 20 emits a line-shaped light ray with which the measurement subject 200 is irradiated, through the opening 70, for example. More specifically, the light source unit 20 includes a light source and an optical member such as a laser line generator lens that converts the light output from the light source into a line-shaped light ray. The light source is not particularly limited, and is a laser light source or an LED (Light Emitting Diode) light source that outputs monochromatic light, for example.

The light receiving unit 30 receives the light reflected from the surface or the like of the measurement subject 200, for example. More specifically, the light receiving unit 30 includes an imaging device such as a CCD (Charge Coupled Device) or a CMOS (Complementary Metal Oxide Semiconductor).

The measurement device 100 measures the shape of the measurement subject 200 in a state where the measurement subject 200 is positioned so as to be separated from the main body 10 as shown in FIG. 1, or in a state where the measurement subject 200 is positioned so as to be in contact with the surface in which the opening 70 of the main body 10 is formed.

For example, the measurement device 100 also includes a light projecting mirror 61, a light receiving mirror 62, an adjustment mechanism 80, an analysis unit 40, and a transparent member 71. The analysis unit 40 is provided outside the main body 10, for example. The adjustment mechanism 80 is provided inside the main body 10, for example. Note that the light projecting mirror 61 may be a total reflection mirror or a half mirror.

The light projecting mirror 61 is provided on the light projection optical path 51 in the main body 10. The light projection optical path 51, which is an optical path extending from the light source unit 20 to the opening 70, includes an optical path extending from the light source unit 20 to the light projecting mirror 61 and an optical path extending from the light projecting mirror 61 to the opening 70.

The light receiving mirror 62 is provided on the light receiving optical path 52 in the main body 10. The light receiving optical path 52, which is an optical path extending from the opening 70 to the light receiving unit 30, includes an optical path extending from the opening 70 to the light receiving mirror 62 and an optical path extending from the light receiving mirror 62 to the light receiving unit 30.

The transparent member 71 closes the opening 70 of the main body 10. The transparent member 71 is provided on the other side of the measurement subject 200 with respect to the opening 70. For example, the width and the length of the surface that faces the opening 70, of the transparent member 71, are longer than the width and the length of the opening 70, respectively.

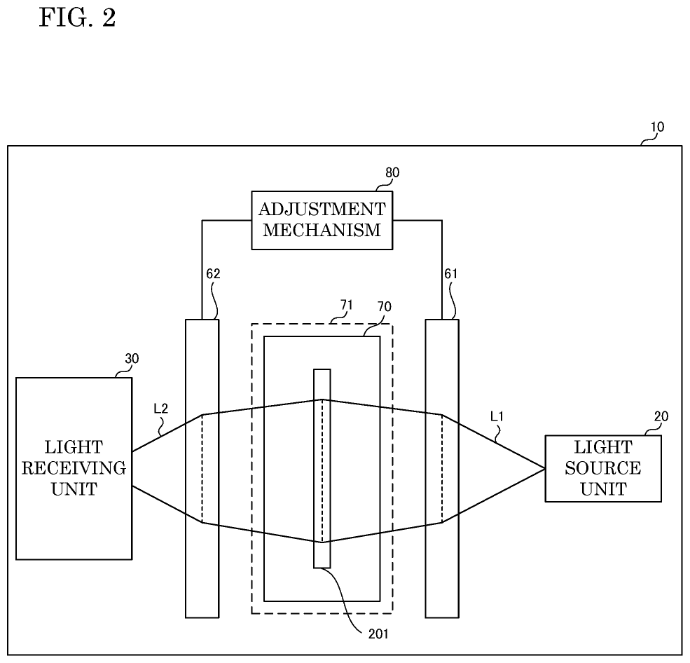

FIG. 2 is a plan view showing light that is emitted from the opening of the measurement device according to the embodiment of the present invention, and with which the measurement subject is irradiated.

As shown in FIGS. 1 and 2, the light source unit 20 emits a line light ray L1, which is a line-shaped light ray, to the light projection optical path 51. More specifically, the light source unit 20 emits the line light ray L1 toward the light projecting mirror 61.

The light projecting mirror 61 reflects the line light ray L1 received from the light source unit 20, and irradiates the measurement subject 200 with the line light ray L1 through the transparent member 71 and the opening 70. For example, the width of the opening 70 is longer than the length thereof in the extension direction of the line light ray L1 that enters the opening 70. The light projecting mirror 61 irradiates a measurement area 201 that is a measurement subject area of the surface of the measurement subject 200, with the line light ray L1 passing through the opening 70 and the transparent member 71. Hereinafter, the length in the extension direction of the line light is also referred to as a line width.

More specifically, the line light ray L1 reflected by the light projecting mirror 61 and emitted from the opening 70 and the transparent member 71 travels along an irradiation optical path 53 that is an optical path on an extension line of the light projection optical path 51 extending from the light projecting mirror 61 to the opening 70, and is an optical path extending from the opening 70 to the measurement subject 200, and the measurement area 201 is irradiated with the line light ray L1.

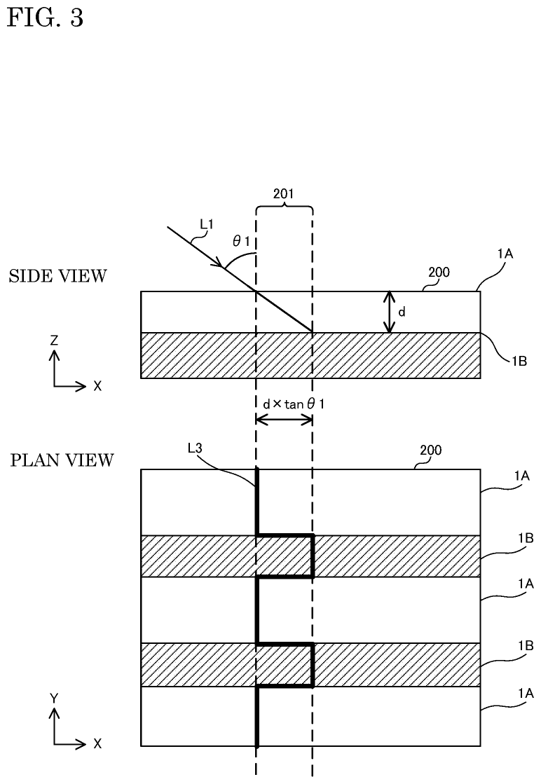

FIG. 3 is a diagram showing a light irradiation line that is formed in the measurement area, by the line light ray emitted from the measurement device according to the embodiment of the present invention, with which the measurement subject is irradiated. FIG. 3 shows a plan view and a side view of the measurement subject 200.

As shown in FIG. 3, the measurement subject 200 has an uneven shape that is constituted by a plurality of protrusions 1A and a plurality of depressions 1B that are arranged in the extension direction of the line light ray L1.

The line light ray L1 emitted from the measurement device 100 input to the measurement area 201 enters the measurement area 201 of the measurement subject 200 at an incident angle θ1, and forms a light irradiation line L3 in the measurement area 201.

In the plan view, the light irradiation line L3 formed on a protrusion 1A and the light irradiation line L3 formed on a depression 1B have an interval corresponding to the incident angle θ1 in a direction that is orthogonal to the extension direction of the line light ray L1.

More specifically, when the level difference between the protrusion 1A and the depression 1B in the measurement area 201 is a level difference d, the distance between the light irradiation line L3 formed on the protrusion 1A and the light irradiation line L3 formed on the depression 1B is d×tan θ1 in a plan view.

The line light ray L1 emitted from the main body 10 of the measurement device 100 so that the measurement area 201 of the measurement subject 200 is irradiated therewith is reflected from the measurement area 201. At least some of the light reflected from the measurement area 201 travels along a reflection optical path 54 and enters the main body 10 via the opening 70 and the transparent member 71.

The light receiving mirror 62 reflects some of the light received from the measurement subject 200 through the opening 70 so that the light receiving unit 30 is irradiated therewith. More specifically, the line light ray L1 emitted from the main body 10 of the measurement device 100 so that the measurement area 201 of the measurement subject 200 is irradiated therewith is reflected and scattered. At least some of the light reflected and scattered by the measurement area 201 enters the main body 10 via the opening 70 and the transparent member 71. The light receiving mirror 62 receives the light reflected and scattered by the measurement area 201, and reflects the received light. At least some of the light reflected by the light receiving mirror 62 enters the light receiving unit 30. Hereinafter, the light that is reflected by the light receiving mirror 62 and enters the light receiving unit 30, of the light reflected and scattered by the measurement area 201, is also referred to as a detection light ray L2.

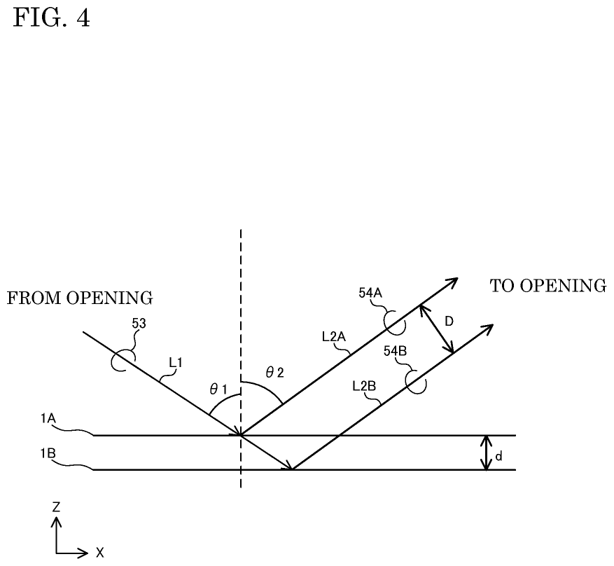

FIG. 4 is a diagram showing a state in which the line light ray emitted from the measurement device according to the embodiment of the present invention so that the measurement subject is irradiated therewith is reflected by the surface of the measurement subject.

As shown in FIG. 4, the line light ray L1 that travels along the irradiation optical path 53 and enters the protrusion 1A of the measurement area 201 at an incident angle θ1 is reflected and scattered by the protrusion 1A. The detection light ray L2 reflected at a reflection angle θ2, of the light reflected and scattered by the protrusion 1A, travels along a reflection optical path 54A, which is an example of the reflection optical path 54, and enters the main body 10 via the opening 70.

Also, the line light ray L1 that enters the depression 1B of the measurement area 201 at the incident angle θ1 is reflected and scattered by the depression 1B. The detection light ray L2 reflected at the reflection angle θ2, of the light reflected and scattered by the protrusion 1B, travels along a reflection optical path 54B, which is an example of the reflection optical path 54, and enters the main body 10 via the opening 70. The reflection optical path 54A and the reflection optical path 54B are substantially parallel with each other with an interval D being interposed therebetween.

Hereinafter, the detection light ray L2 that travels along the reflection optical path 54A and enters the main body 10 via the opening 70 is also referred to as a detection light ray L2A, and the detection light ray L2 that travels along the reflection optical path 54B and enters the main body 10 via the opening 70 is also referred to as a detection light ray L2B.

Again, as shown in FIGS. 1 and 2, the detection light ray L2A and the detection light ray L2B reflected in the measurement area 201 and reflected by the light receiving mirror 62 are received by the light receiving unit 30.

The adjustment mechanism 80 can adjust the incident angle of the light ray entering the opening 70 from the light projection optical path 51. For example, the adjustment mechanism 80 is a stage for adjusting the incident angle and the position of the light on the reflection surfaces of the light projecting mirror 61 and the light receiving mirror 62. This stage rotates the light projecting mirror 61 and the light receiving mirror 62 about predetermined rotation axes and moves the light projecting mirror 61 and the light receiving mirror 62, through a manual operation or according to a control signal from a control unit (not shown).

More specifically, the adjustment mechanism 80 adjusts the incident angle at which the line light ray L1 reflected by the light projecting mirror 61 enters the opening 70, by rotating the light projecting mirror 61 about a predetermined rotation axis. In other words, the adjustment mechanism 80 can adjust the incident angle of the line light ray L1 entering the measurement area 201 by rotating the light projecting mirror 61 about a predetermined rotation axis. The incident angle θ1 and the reflection angle θ2 of the line light ray L1 entering the measurement area 201 is set to 30°, for example.

Also, the adjustment mechanism 80 adjusts the incident angle at which the light reflected in the measurement area 201 enters the light receiving mirror 62, by rotating the light receiving mirror 62 about a predetermined rotation axis, so that a larger amount of light, of the light reflected in the measurement area 201, is reflected by the light receiving mirror 62 and enters the light receiving unit 30, for example.

Also, the adjustment mechanism 80 moves the light projecting mirror 61 and the light receiving mirror 62 along a straight line that connects the light source unit 20 and the light receiving unit 30, i.e., in the direction indicated by the block arrows in FIG. 1, while rotating the light projecting mirror 61 and the light receiving mirror 62, for example.

The light receiving unit 30 receives the detection light rays L2A and L2B reflected from the measurement area 201 and reflected by the light receiving mirror 62.

For example, the length of the light receiving unit 30 in the direction orthogonal to the width of the light-receiving surface thereof is longer than the interval D between the reflection optical path 54A of the detection light ray L2A and the reflection optical path 54B of the detection light ray L2B.

Note that FIG. 4 only shows the detection light ray L2A reflected by one protrusion 1A shown in FIG. 3 and the detection light ray L2B reflected by one depression 1B shown in FIG. 3. When a measurement subject 200 provided with a plurality of protrusions 1A and a plurality of depressions 1B is irradiated with the line light ray L1, a plurality of sets each composed of the detection light rays L2A and L2B reflected along the pair of reflection optical paths 54A and 54B shown in FIG. 4 are arranged in the direction orthogonal to the sheet of the drawing.

The light receiving unit 30 transmits the result of receiving the detection light rays L2A and L2B to the analysis unit 40.

The analysis unit 40 analyzes the shape of the measurement subject 200 based on the light reception result of the light receiving unit 30.

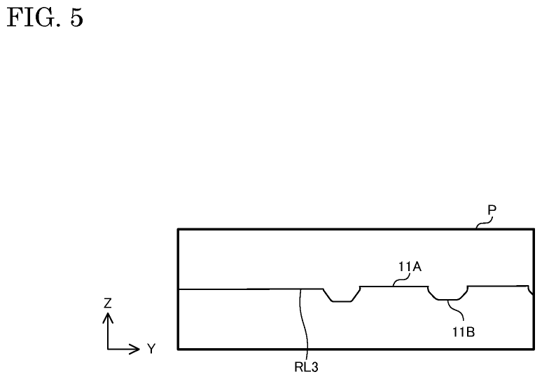

FIG. 5 is a diagram showing an example of an image generated by the analysis unit of the measurement device according to the embodiment of the present invention.

As shown in FIG. 5, the analysis unit 40 generates an image P that includes a luminance line RL3 corresponding to the light irradiation line L3 generated on the measurement area 201, based on the light reception result of the light receiving unit 30. The luminance line RL3 includes protrusions 11A corresponding to protrusions 1A of the measurement area 201 and depressions 11B corresponding to depressions 1B of the measurement area 201.

The analysis unit 40 analyzes the shape of the surface or the like of the measurement area of the measurement subject 200 based on the image P thus generated. More specifically, the analysis unit 40 calculates the level difference d between the protrusion 1A and the depression 1B in the measurement area 201 of the measurement subject 200.

More specifically, for example, the number of pixels between the protrusion 11A and the depression 11B of the luminance line RL3 in the Z axis direction is proportional to the interval D between an optical path LPA of the detection light ray L2A and an optical path LPB of the detection light ray L2B.

The analysis unit 40 calculates the interval D between the optical path LPA of the detection light ray L2A and the optical path LPB of the detection light ray L2B by multiplying the number of pixels between the protrusion 11A and the depression 11B of the luminance line RL3 in the Z axis direction by a predetermined coefficient.

The analysis unit 40 calculates the level difference d between the protrusion 1A and the depression 1B of the measurement area 201 according to Formula (1) shown below, based on the interval D thus calculated.

$$\begin{matrix}[ Math . 1 ] & \\ d = \frac{D}{cos θ 2 \times ( tan θ 1 + tan θ 2 )} & ( 1 )\end{matrix}$$

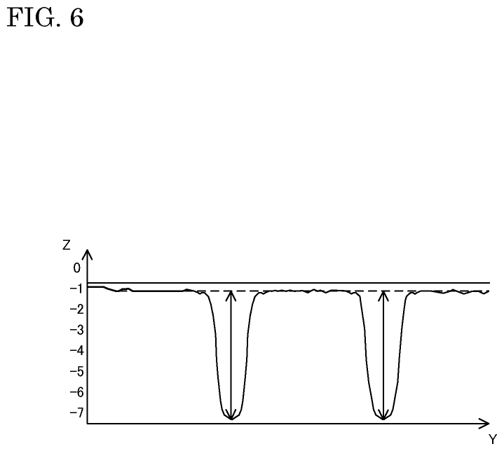

FIG. 6 is a diagram showing the result of the analysis of the surface shape of the measurement subject performed by the analysis unit of the measurement device according to the embodiment of the present invention. The horizontal axis in FIG. 6 indicates a position in the measurement area 201 of the measurement subject 200 in the extension direction of the line light ray L1, and the vertical axis indicates a position in the direction orthogonal to the surface of the measurement subject 200.

As shown in FIG. 6, the analysis unit 40 calculates that the two level differences d between the protrusions 1A and the depressions 1B formed in the measurement area 201 are 7.0 mm and 6.9 mm, based on the interval D between the optical path LPA and the optical path LPB and Formula (1).

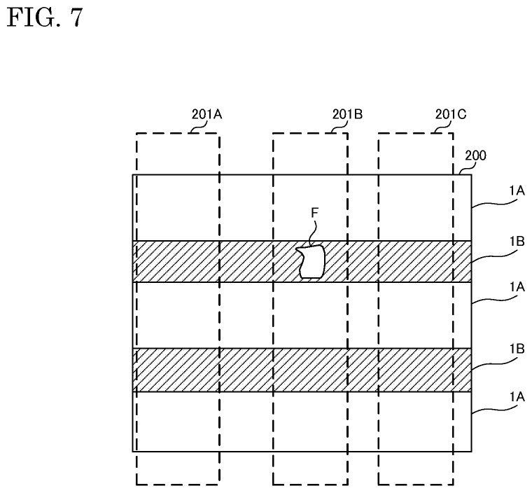

FIG. 7 is a plan view showing an example of a measurement area that is to be irradiated with a line light ray emitted from the measurement device according to the embodiment of the present invention.

As shown in FIG. 7, the light source unit 20 irradiates a plurality of measurement areas 201A, 201B, and 201C of the measurement subject 200 with the line light rays L1 at the same time or separately, for example.

The light receiving unit 30 receives the detection light rays L2 reflected from the measurement areas 201A, 201B, and 201C, via the light receiving mirror 62.

Based on the light reception result of the light receiving unit 30, the analysis unit 40 generates an image PA that includes the luminance line RL3 corresponding to the light irradiation line L3 in the measurement area 201A, an image PB that includes the luminance line RL3 corresponding to the light irradiation line L3 in the measurement area 201B, and an image PC that includes the luminance line RL3 corresponding to the light irradiation line L3 in the measurement area 201C.

The analysis unit 40 analyzes the images PA, PB, and PC thus generated. For example, the analysis unit 40 detects an object other than the measurement subject 200 by analyzing the images PA, PB, and PC thus generated.

More specifically, the analysis unit 40 analyzes the images PA, PB, and PC respectively corresponding to the plurality of measurement areas 201A, 201B, and 201C, using an image processing method such as pattern matching, and detects an abnormality in the measurement areas 201A, 201B, and 201C based on the result of the analysis.

More specifically, the analysis unit 40 compares the images PA, PB, and PC with each other using a pattern matching method, to detect the presence of foreign matter in the measurement areas 201A, 201B, and 201C.

In the example shown in FIG. 7, foreign matter F is present in the depression 1B of the measurement area 201B. The analysis unit 40 compares the generated images PA, PB, and PC with each other using a pattern matching method, to detect that the foreign matter F is visible in the image PB.

When the foreign matter F is present in the depression 1B of the measurement area 201B, it may be impossible to accurately calculate the level difference d between the protrusion 1A and the depression 1B in the measurement area 201B. Therefore, for example, if the presence of the foreign matter F is detected in the depression 1B of the measurement area 201B, the analysis unit 40 analyzes the surface shapes of the measurement areas 201A and 201C, but does not analyze the surface shape of the measurement area 201B.

For example, the analysis unit 40 generates images PA1, PB1, and PC1 using light in a wavelength band different from the wavelength of the line light ray L1 based on the light reception result of the light receiving unit 30, and analyzes the images PA1, PB1, and PC1 thus generated.

More specifically, for example, the light source unit 20 includes a low wavelength band laser light source and emits a line light ray L1 in a low wavelength band.

Thereafter, the analysis unit 40 generates images PA1, PB1, and PC1 using light in a wavelength band higher than the wavelength band of the line light ray L1, and analyzes the images PA1, PB1, and PC1 thus generated. As a result, it is possible to reduce the influence of the light irradiation line L3 formed in the measurement area 201 on the analysis of the imeges PA1, PB1, and PC1 performed by the analysis unit 40.

In addition, in order to facilitate the analysis of the images PA1, PB1, and PC1 by the analysis unit 40, the measurement device 100 may have a configuration in which, for example, an illumination unit that irradiates the measurement area 201 with visible light is provided at a given position inside the main body 10, for example.

If this is the case, the light receiving unit 30 receives light in the visible light band emitted from the illumination unit and reflected by the measurement area 201. Thereafter, the analysis unit 40 generates images PA1, PB1, and PC1 using light in the visible light band, and analyzes the images PA1, PB1, and PC1 thus generated. As a result, it is possible to reduce the influence of the light irradiation line L3 formed in the measurement area 201 on the analysis of the imeges PA1, PB1, and PC1 performed by the analysis unit 40.

### Measurement Example 1

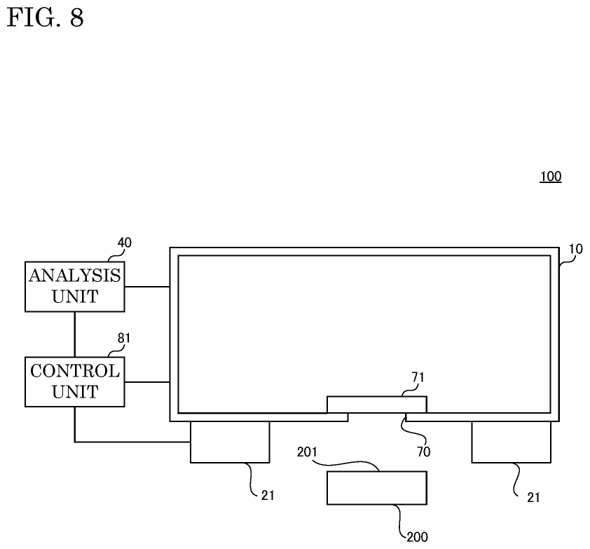

FIG. 8 is a diagram showing an example of the content of a measurement performed by the measurement device according to the embodiment of the present invention. Note that FIG. 8 does not show the components provided in the main body 10 of the measurement device 100, to simplify the description thereof.

As shown in FIG. 8, the measurement device 100 includes a control unit 81. The measurement device 100 measures the shape of the measurement subject 200 in a state where the opening 70 faces downward in the vertical direction. The measurement device 100 can measure the surface shape of a measurement subject 200 that is difficult to carry, such as a Braille block installed on the ground.

More specifically, the measurement device 100 includes a moving mechanism 21 that can move the main body 10 in one or more directions.

The control unit 81 drives the moving mechanism 21 by transmitting a control signal for controlling the moving mechanism 21 to the moving mechanism 21 so that the opening 70 of the main body 10 and the measurement area 201 face each other. More specifically, the control unit 81 drives the moving mechanism 21 to move the main body 10 in one or more horizontal directions so that the opening 70 is located above the measurement area 201 of the Braille block, for example.

The control unit 81 performs control to, for example, start and stop the emission of the line light ray L1 performed by the light source unit 20, and start and stop the analysis performed by the analysis unit 40, in a state where the opening 70 of the main body 10 is located above the measurement area 201.

The analysis unit 40 transmits the analysis result indicating the level difference d of the uneven shape of the measurement area 201 to the control unit 81.

The control unit 81 transmits the analysis result received from the analysis unit 40 to a device outside the measurement device 100 via a wire or wirelessly.

### Measurement Example 2

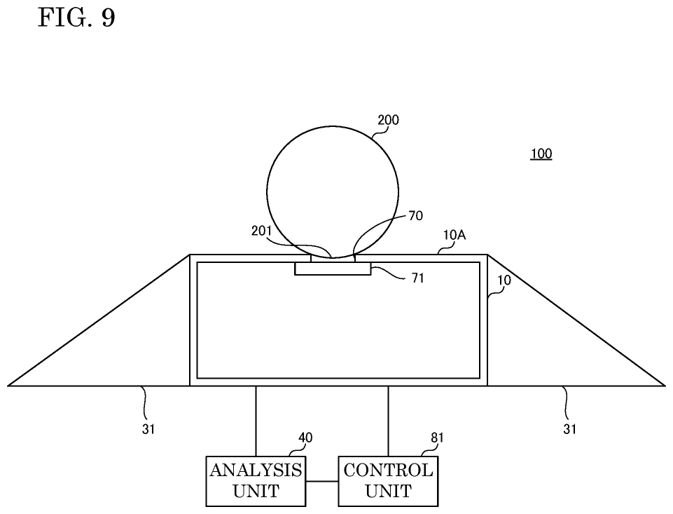

FIG. 9 is a diagram showing another example of the content of a measurement performed by the measurement device according to the embodiment of the present invention. Note that FIG. 9 does not show the components provided in the main body 10 of the measurement device 100, to simplify the description thereof.

As shown in FIG. 9, the measurement device 100 measures the shape of the measurement subject 200 in a state where the opening 70 faces upward in the vertical direction. The measurement device 100 can measure the surface shape of a measurement subject 200 that has a circular shape, for example.

More specifically, a pair of sloped portions 31 are provided so as to sandwich the measurement device 100. For example, when the surface shape of the measurement subject 200 that has a cylindrical shape is to be measured, the measurement subject 200 is moved while being rotated so that the measurement subject 200 passes over the opening 70 in an upper surface 10A of the main body 10 via the sloped portions 31.

The control unit 81 performs control to, for example, start and stop the emission of the line light ray L1 performed by the light source unit 20, and start and stop the analysis performed by the analysis unit 40, in a state where the measurement area 201 of the measurement subject 200 is located above the opening 70 of the main body 10.

The analysis unit 40 transmits the analysis result indicating the level difference d of the uneven shape of the measurement area 201 to the control unit 81.

The control unit 81 transmits the analysis result received from the analysis unit 40 to a device outside the measurement device 100 via a wire or wirelessly.

As described above, the measurement device 100 can measure the surface shape of a measurement subject 200 that has a circular shape, such as a tire attached to a vehicle, for example. For example, by sequentially moving a plurality of vehicles so that the tires sequentially pass over the opening 70 in the upper surface 10A of the main body 10, it is possible to continuously measure the shapes of the plurality of tires attached to the vehicles, using the measurement device 100.

For example, the measurement device 100 includes a license plate reading device (not shown). The control unit 81 acquires the vehicle number on a license plate of a vehicle detected by the license plate reading device. The control unit 81 transmits the analysis result received from the analysis unit 40 to a device outside the measurement device 100 in association with the vehicle number thus acquired.

For example, the measurement device 100 includes two main bodies 10. The two main bodies 10 are located separate from each other so that the interval between the respective openings 70 thereof corresponds to the interval between the left and right tires of the vehicles, and simultaneously measure the surface shapes of the left and right tires of each vehicle.

For example, tires, which are measurement subjects 200, do not come into contact with the transparent members 71 in a state where the measurement areas 201 are located above the openings 70 of the main bodies 10. With such a configuration, it is possible to prevent the measurement areas 201 from deforming due to the weight of the measurement subjects 200 themselves, and therefore it is possible to accurately measure the surface shapes of the measurement areas 201.

### Modification

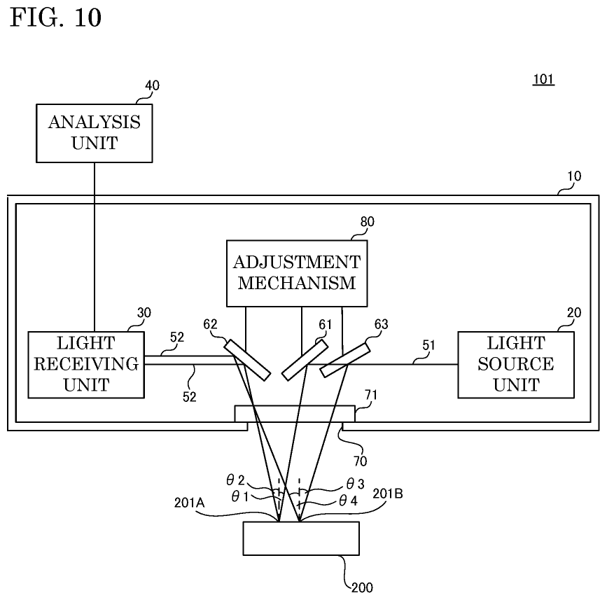

FIG. 10 is a side view showing a configuration of a measurement device according to a modification of the embodiment of the present invention.

As shown in FIG. 10, when compared with the measurement device 100 shown in FIG. 1, a measurement device 101 further includes a half mirror 63 that is provided at a position on the light projection optical path 51 between the light source unit 20 and the light projecting mirror 61.

The light source unit 20 emits a line light ray L1, which is a line-shaped light ray, to the light projection optical path 51. More specifically, the light source unit 20 emits the line light ray L1 toward the light projecting mirror 61.

A half mirror 63 allows a portion of the line light ray L1 received from the light source unit 20 to pass therethrough while reflecting the remaining portion, and irradiates the measurement subject 200 with the line light ray L1 through the transparent member 71 and the opening 70.

The light projecting mirror 61 reflects the line light ray L1 passing through the half mirror 63, and irradiates the measurement subject 200 with the line light ray L1 through the transparent member 71 and the opening 70.

More specifically, the light projecting mirror 61 irradiates the measurement area 201A of the measurement subject 200 with the line light ray L1 through the opening 70. The half mirror 63 irradiates the measurement area 201B of the measurement subject 200 different from the measurement area 201A with the line light ray L1 through the opening 70. That is to say, the light projecting mirror 61 and the half mirror 63 simultaneously irradiate the plurality of measurement areas 201A and 201B of the measurement subject 200 with the line light rays L1.

In the example shown in FIG. 10, the measurement device 101 includes one half mirror 63, but the measurement device 101 may include two or more half mirrors 63. For example, in the case of a measurement device 101 that includes three half mirrors 63, the light projecting mirror 61 and two half mirrors 63 simultaneously irradiate the three measurement areas 201A, 201B, and 201C of the measurement subject 200 with the line light rays L1.

The line light ray L1 reflected by the light projecting mirror 61 and emitted from the measurement device 100 enters the measurement area 201A at an incident angle θ1, and forms a light irradiation line L3 in the measurement area 201A. The line light ray L1 reflected by the half mirror 63 and emitted from the measurement device 100 enters the measurement area 201B at an incident angle θ3 different from the incident angle θ1, and forms a light irradiation line L3 in the measurement area 201B.

The line light ray L1 from the light projecting mirror 61 entering the measurement area 201A at the incident angle θ1 is reflected and scattered by the measurement area 201A. The detection light ray L2 reflected at the reflection angle θ2, of the light reflected and scattered by the measurement area 201A, enters the main body 10 via the opening 70.

The line light ray L1 from the half mirror 63 entering the measurement area 201A at the incident angle θ3 is reflected and scattered by the measurement area 201B. The detection light ray L2 reflected at a reflection angle θ4, of the light reflected and scattered by the measurement area 201B, enters the main body 10 via the opening 70.

The detection light ray L2 reflected by the measurement area 201A and reflected by the light receiving mirror 62, and the detection light ray L2 reflected by the measurement area 201B and reflected by the light receiving mirror 62, are received by the light receiving unit 30.

The adjustment mechanism 80 adjusts the incident angle at which the line light ray L1 reflected by the half mirror 63 enters the opening 70, by rotating the half mirror 63 about a predetermined rotation axis.

More specifically, the adjustment mechanism 80 adjusts the incident angle at which the line light ray L1 reflected by the half mirror 63 enters the opening 70, so that the detection light ray L2 reflected by the measurement area 201A and the detection light ray L2 reflected by the measurement area 201B are reflected by the light receiving mirror 62 and enter different positions on the light-receiving surface of the light receiving unit 30.

The light receiving unit 30 receives the detection light ray L2 reflected by the measurement area 201A and the detection light ray L2 reflected by the measurement area 201B in different areas of the light-receiving surface, and transmits the light reception result to the analysis unit 40.

The analysis unit 40 analyzes the shape of the surface or the like of the measurement subject 200 in the measurement areas 201A and 201B based on the light reception result of the light receiving unit 30. More specifically, the analysis unit 40 generates an image P that includes two luminance lines RL3 corresponding to the measurement area 201A and the measurement area 201B, and analyses the shape of the surface of the measurement subject 200 in the measurement areas 201A and 201B based on the image P thus generated.

### Operation Flow

The measurement device according to the embodiment of the present invention is provided with a computer that includes a memory, and a calculation unit such as a CPU of the computer reads out a program that includes some or all of the steps of the following flowchart from the memory, and executes the program. The programs for these devices can be installed from the outside, respectively. The programs for these devices are distributed in a state of being stored in a recording medium, respectively.

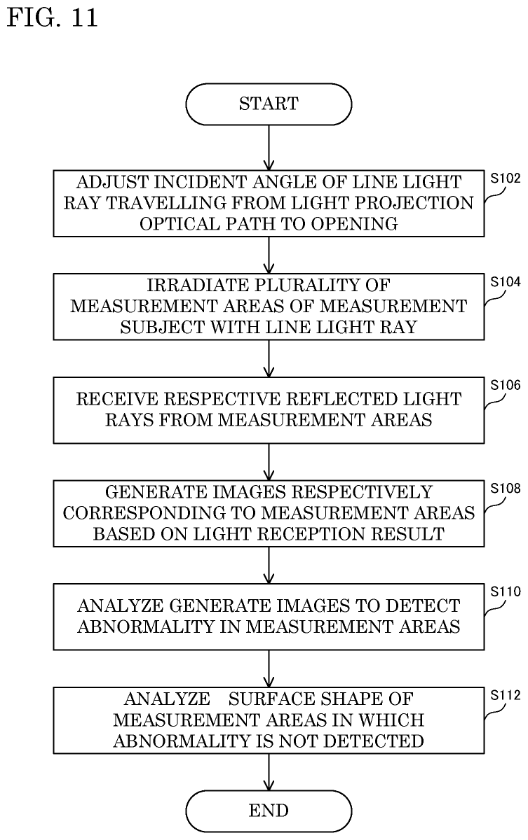

FIG. 11 is a flowchart showing operation procedures that are performed by the measurement device according to the embodiment of the present invention when analyzing the surface shape of the measurement area of the measurement subject.

As shown in FIG. 11, first, the measurement device 100 adjusts the incident angle of a light ray travelling from the light projection optical path 51 to the opening 70, using the adjustment mechanism 80 (step S102).

Next, the measurement device 100 irradiates the measurement areas 201A, 201B, and 201C of the measurement subject 200 with the line light ray L1 via the light projection optical path 51 and the opening 70 in a state where the opening 70 of the main body 10 faces the measurement area 201 of the measurement subject 200. For example, the measurement device 100 includes two half mirrors 63, and simultaneously irradiates the measurement areas 201A, 201B, and 201C with line light rays L1 (step S104).

Next, the measurement device 100 receives the reflected light rays from the measurement areas 201A, 201B, and 201C via the opening 70 and the light receiving optical path 52 (S106).

Next, the measurement device 100 generates images PA, PB, and PC respectively corresponding to the measurement areas 201A, 201B, and 201C, based on the light reception result of the reflected light rays from the measurement areas 201A, 201B, and 201C (step S108).

Next, the measurement device 100 analyzes the generated images PA, PB, and PC using an image processing method such as pattern matching, to detect an abnormality in the measurement areas 201A, 201B, and 201C based on the analysis result (step S110).

Next, if an abnormality is detected in the measurement area 201B, for example, the measurement device 100 analyzes the shapes of the surfaces or the like of the measurement areas 201A and 201C based on the light reception result of the reflected light rays from the measurement areas 201A and 201C in which no abnormality is detected (step S112).

Although the measurement devices 100 and 101 according to the embodiment of the present invention employ a configuration in which the light source unit 20 and the light receiving unit 30 are provided inside the main body 10, the present invention is not limited to such a configuration. It is possible to employ a configuration in which at least either the light source unit 20 or the light receiving unit 30 may be provided outside the main body 10.

Also, although the measurement devices 100 and 101 according to the embodiment of the present invention employ a configuration in which the light source unit 20 emits a line light ray L1, the present invention is not limited to such a configuration. The light source unit 20 may be configured to emit a beam-shaped light ray. If this is the case, the measurement devices 100 and 101 include an optical member for converting light emitted from the light source unit 20 into a line light ray L1, provided on the light projection optical path 51, for example. Light emitted from the light source unit 20 is converted by the optical member into a line light ray L1, with which the measurement subject 200 is irradiated via the transparent member 71 and the opening 70.

Also, although the measurement devices 100 and 101 according to the embodiment of the present invention employ a configuration in which the light projecting mirror 61 is provided, the present invention is not limited to such a configuration. The measurement devices 100 and 101 may be configured without the light projecting mirror 61. If this is the case, the light source unit 20 is provided inside or outside the main body 10 so as to face the measurement subject 200 with the opening 70 being interposed therebetween, and irradiates the measurement area 201 of the measurement subject 200 with a line light ray L1 via the transparent member 71 and the opening 70.

Also, although the measurement devices 100 and 101 according to the embodiment of the present invention employ a configuration in which the light receiving mirror 62 is provided, the present invention is not limited to such a configuration. The measurement devices 100 and 101 may be configured without the light receiving mirror 62. If this is the case, the light receiving unit 30 is provided inside or outside the main body 10 so as to face the measurement subject 200 with the opening 70 being interposed therebetween, and receives at least a portion of the light ray reflected by the measurement area 201 of the measurement subject 200 and entering the main body 10, as a detection light ray L2.

Also, although the measurement devices 100 and 101 according to the embodiment of the present invention employ a configuration in which the analysis unit 40 is provided, the present invention is not limited to such a configuration. The measurement devices 100 and 101 may be configured without the analysis unit 40. If this is the case, the light receiving unit 30 transmits the light reception result to an external device wirelessly or via a wire.

Also, although the measurement devices 100 and 101 according to the embodiment of the present invention employ a configuration in which the analysis unit 40 analyzes the images PA, PB, and PC respectively corresponding to the measurement areas 201A, 201B, and 201C to detect an abnormality in the measurement areas 201A, 201B, and 201C, the present invention is not limited to such a configuration. It is possible to employ a configuration in which the analysis unit 40 does not generate images PA, PB, and PC, and does not detect an abnormality in the measurement areas 201A, 201B, and 201C.

Also, although the measurement devices 100 and 101 according to the embodiment of the present invention employ a configuration in which the adjustment mechanism 80 is provided, the present invention is not limited to such a configuration. The measurement devices 100 and 101 may be configured without the adjustment mechanism 80. That is to say, the light projecting mirror 61 and the light receiving mirror 62 may be fixed.

Also, although the measurement devices 100 and 101 according to the embodiment of the present invention employ a configuration in which the transparent member 71 for closing the opening 70 is provided, the present invention is not limited to such a configuration. The measurement devices 100 and 101 may be configured without the transparent member 71.

Also, although the measurement devices 100 and 101 according to the embodiment of the present invention employ a configuration in which the transparent member 71 is provided on the other side of the measurement subject 200 with respect to the opening 70, the present invention is not limited to such a configuration. It is possible to employ a configuration in which the transparent member 71 is provided on the same side as the measurement subject 200 with respect to the opening 70, or a configuration in which the transparent member 71 is attached to the main body 10 so as to fill the opening 70.

The foregoing embodiments are to be construed in all respects as illustrative and not restrictive. The scope of the present invention is defined by the claims rather than the description above, and is intended to include all modifications within the meaning and scope of the claims and equivalents thereof.

### DESCRIPTIONS OF REFERENCE NUMERALS

10 Main body
10A Upper surface
20 Light source unit
21 Moving mechanism
30 Light receiving unit
31 Sloped portion
40 Analysis unit
51 Light projection optical path
52 Light receiving optical path
53 Irradiation optical path
54 Reflection optical path
61 Light projecting mirror
62 Light receiving mirror
63 Half mirror
70 Opening
71 Transparent member
80 Adjustment mechanism
81 Control unit
100 Measurement device
101 Measurement device
200 Measurement subject
201 Measurement area

1. A measurement device for measuring the shape of a measurement subject, comprising:
a light source unit;
a light receiving unit; and
a main body that includes a light passing portion from which a line-shaped light ray is emitted, a light projection optical path that is an optical path extending from the light source unit to the light passing portion, and a light receiving optical path that is an optical path extending from the light passing portion to the light receiving unit.

2. The measurement device according to claim 1, further comprising:
a light projecting mirror that is provided on the light projection optical path; and
a light receiving mirror that is provided on the light receiving optical path,
wherein the light projecting mirror reflects light received from the light source unit so that the measurement subject is irradiated therewith through the light passing portion, and
the light receiving mirror reflects at least some of the light received from the measurement subject through the light passing portion so that the light receiving unit is irradiated therewith.

3. The measurement device according to claim 2, further comprising
a half mirror that is provided at a position on the light projection optical path between the light source unit and the light projecting mirror.

4. The measurement device according to claim 1, further comprising
an analysis unit that analyzes the shape of the measurement subject based on a light reception result of the light receiving unit,
wherein the analysis unit further generates an image based on the light reception result of the light receiving unit, and detects an object other than the measurement subject based on an analysis result of the image thus generated.

5. The measurement device according to claim 1, further comprising
an adjustment mechanism configured to adjust an incident angle of a light ray travelling from the light projection optical path to the light passing portion.

6. The measurement device according to claim 1,
wherein the light passing portion is an opening,
the main body further includes a transparent member that closes the opening, and
the transparent member is provided on the other side of the measurement subject with respect to the opening.

7. A measurement method carried out by a measurement device for measuring the shape of a measurement subject, the measurement device including a main body, the main body including a light passing portion, a light projection optical path, and a light receiving optical path, the measurement method comprising:
a step of irradiating the measurement subject with a line-shaped light ray that enters the light projection optical path or a line-shaped light ray that is generated on the light projection optical path, through the light passing portion; and
a step of receiving a reflected light ray from the measurement subject, through the light passing portion and the light receiving optical path.
